(19) United States
(12) Patent Application Publication
(10) Pub. No.: US 2013/0034053 A1
(43) Pub. Date: Feb. 7, 2013

(54) METHOD AND SYSTEM FOR SCALABLE INFORMATION PACKETIZATION AND AGGREGATION FOR INFORMATION TRANSMISSION IN COMMUNICATION NETWORKS

(71) Applicants: Huai-Rong Shao, San Jose, CA (US); Chiu Ngo, San Francisco, CA (US)

(72) Inventors: Huai-Rong Shao, San Jose, CA (US); Chiu Ngo, San Francisco, CA (US)

(73) Assignee: SAMSUNG ELECTRONICS CO., LTD., Suwon (KR)

(21) Appl. No.: 13/563,388

(22) Filed: Jul. 31, 2012

Related U.S. Application Data
(60) Provisional application No. 61/513,964, filed on Aug. 1, 2011.

(51) Int. Cl. H04W 4/00; H04L 29/02

(52) U.S. Cl. 370/328; 370/474

(57) ABSTRACT

Information communication in a communication network comprises organizing information based on importance levels of the information. The information is aggregated in a packet based on said organization for transmission over a communication medium. Aggregating the information includes placing the information in the packet utilizing a scalable packet structure based on said organization. Information for a packet is partitioned based on information type, and organized in an aggregated packet in a pyramid format. Information in a packet can be organized/coded in a two-dimensional pyramid format for forwarding information from one or more communication devices. A first dimension includes information importance level and a second dimension includes device priorities based on a distance calculation.

### CROSS-REFERENCE TO RELATED APPLICATION

This application claims priority benefit under 35 U.S.C. §119(e) of U.S. Provisional Patent Application Ser. No. 61/513,964, filed on Aug. 1, 2011, incorporated herein by reference.

### FIELD OF THE INVENTION

The present invention relates generally to data communication, and in particular to scalable information packetization and aggregation for information transmission in communication networks.

### DESCRIPTION OF RELATED ART

In wired and wireless communication systems such as Ethernet and Wi-Fi, the packet payload is transparent to communication protocol layers such a network layer, a media access layer (MAC) layer and a physical (PHY) layer. To use Wi-Fi as an example, the MAC layer does not understand the information structure in a MAC Service Data Unit (MSDU) and treats such information as a group of bits or bytes that need to be passed to the PHY layer as a whole together after adding the MAC header. This characteristic is unsuitable for satisfying scalability requirements in communication systems with large number of devices (users).

### BRIEF SUMMARY OF THE INVENTION

Embodiments of the invention relate to scalable information packetization and aggregation for information transmission in communication networks.

According to an embodiment of the invention, information communication in a communication network comprises organizing information based on importance levels of the information. The information is aggregated in a packet based on said organization for transmission over a communication medium. Aggregating the information includes placing the information in the packet utilizing a scalable packet structure based on said organization.

In one embodiment, information for a packet is partitioned based on information type, and organized in an aggregated packet in a pyramid format. In one embodiment, information in a packet is organized/coded in a two-dimensional pyramid format for forwarding information from one or more communication devices. A first dimension includes information importance level and a second dimension includes device priorities based on a distance calculation.

These and other features, aspects and advantages of the present invention will become understood with reference to the following description, appended claims and accompanying figures.

### BRIEF DESCRIPTION OF THE DRAWINGS

For a fuller understanding of the nature and advantages of the invention, as well as a preferred mode of use, reference should be made to the following detailed description read in conjunction with the accompanying drawings, in which:

FIG. 1 illustrates an example for scalable information packetization for information communication between communication devices, according to an embodiment of the invention.

FIG. 2 illustrates an implementation of scalable information packetization and aggregation, wherein information is organized by ordering the information in a packet based on information importance levels first, and non-important (or low importance) information in the first dimension for each communication device is dropped first by a forwarding device, according to an embodiment of the invention.

FIG. 3 illustrates another implementation of scalable information packetization and aggregation, wherein the information is organized by ordering the information in a packet based on device importance levels first, and then all information from certain low-priority devices can be dropped first, according to an embodiment of the invention.

FIG. 4 illustrates another implementation of scalable information packetization and aggregation using fine-granular scalable information packetization and aggregation, according to an embodiment of the invention.

FIG. 5A shows a block diagram of an example wireless communication network system, implementing scalable information packetization and aggregation, according to an embodiment of the invention.

FIG. 5B shows a block diagram of an example wireless communication network system, implementing scalable information packetization and aggregation for an AV application, according to an embodiment of the invention.

FIG. 6 shows an example network of communication devices, according to an embodiment of the invention.

FIG. 7 shows a flowchart of a process for scalable information packetization and aggregation for information transmission in a communication, according to an embodiment of the invention.

FIG. 8 is a high level block diagram showing an information processing system comprising a computer system useful for implementing an embodiment of the invention.

### DETAILED DESCRIPTION

The following description is made for the purpose of illustrating the general principles of the invention and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

The present invention relates to scalable information packetization and aggregation for information transmission in different communication networks such as proximity device-to-device network (PDDN) or content oriented network (CON). Scalable information packetization and aggregation according to embodiments of the invention provide simplified adjustment of the amount of information carried in a packet from one or more communication devices to other device(s) in a communication network.

In one example, PDDN allows communication devices to communication with each other directly without an access point or base station within a certain proximity. In one example, CON is an alternative approach to the architecture of computer networks, wherein a communication network allows a user to focus on the data he or she needs, rather than having to reference a specific, physical location where that data is to be retrieved from.

Generally, the OSI standard provides a seven-layered hierarchal protocol for communication between communication devices including wired/wireless transceivers. The OSI standard includes a physical layer, a data link layer, a network layer, a transport layer, a session layer, a presentation layer and an application layer. The IEEE 802 standard provides a multi-layered architecture for local networks that approximate the physical layer and the data link layer of the OSI standard. The layered architecture in the IEEE 802 standard includes a PHY layer, a (MAC layer, and a logical link control (LLC) layer. The PHY layer operates as that in the OSI standard. The MAC and LLC layers share the functions of the data link layer in the OSI standard. The LLC layer places data into frames that can be communicated at the PHY layer, and the MAC layer manages communication over the data link, sending data frames and receiving acknowledgement (ACK) frames. Together the MAC and LLC layers are responsible for error checking as well as retransmission of frames that are not received and acknowledged.

In one implementation for wireless communication over radio frequency channels, a frame structure is used for data communication between wireless stations such as a transmitting (transmitter) station and a receiving (receiver) station. In one example, a frame structure in a MAC layer and a PHY layer is utilized, wherein in a transmitter station, a MAC layer receives a MAC Service Data Unit (MSDU) and attaches a MAC header thereto, in order to construct a MAC Protocol Data Unit (MPDU). The MAC header includes information such as a source address (SA) and a destination address (DA). A number of MPDUs can also be aggregated into an Aggregated MPDU (A-MPDU) to increase MAC layer throughput. The MPDU or A-MPDU is a part of a PHY Service Data Unit (PSDU) and is transferred to a PHY layer in the transmitter to attach a PHY header (i.e., PHY preamble) thereto to construct a PHY Protocol Data Unit (PPDU). The PHY header includes parameters for determining a transmission scheme including a coding/modulation scheme. The PHY layer includes transmission hardware for transmitting data bits over a wireless link. Before transmission as a frame from the transmitter station to the receiver station, a preamble is attached to the PPDU, wherein the preamble can include channel estimation and synchronization information.

In wired and wireless communication systems such as Ethernet and Wi-Fi, the packet payload is transparent to communication protocol layers comprising the network layer, MAC layer and PHY layer. To use Wi-Fi as an example, the MAC layer does not understand the information structure in an MSDU and treats such information as a group of bits or bytes that need to be passed to the PHY layer as a whole together after adding the MAC header. This characteristic is unsuitable for satisfying scalability requirements in communication systems with large number of users.

Specifically, upon communication link adaptation and reduction in available communication channel bandwidth, certain information needs to be eliminated from transmission. This is achieved by data reorganization including placing information with different importance levels in different packets and dropping low priority packets first. However, this approach requires complex receiver design that recognizes data reorganizing into different packets. Further, such information-importance-based packet differentiation generates more packets, degrading communication channel use efficiency in contention-based channel access schemes. Further, in a PDDN or CON, a communication device in a communication network may forward information from other communication devices by aggregating multiple packets. When link adaptation is necessary, simply dropping packets from other communication devices results in fairness issues.

As both wired and wireless networks achieve increasingly higher communications speeds (e.g., 100 Gbps optical network or several Gbps millimeter-wave wireless communication), such high speed communication favors large packet size for efficiency optimization. On the other hand, internet traffic mixes up different types of data information. For example, one typical webpage may include multiple text fields, multiple images, possibly sound, animation and video. The entire or part of the webpage could be transmitted in one packet. Certain information in the packet may need to be dropped if the link bandwidth is reduced when large number of users request the same webpage simultaneously. It is difficult for a communication layer to recognize which information should be dropped because the communication layer is unaware of packet payload content. Simple truncation of the packet payload may cause important information loss. Therefore, for such packetization schemes for Wi-Fi or cellular networks using a flat packet structure, the information in the packet payload cannot be partially dropped for transmission purposes.

In one embodiment, the present invention provides a scalable information packetization and aggregation scheme for adjusting the amount of information carried in a communication packet from a single communication device or multiple communication devices, in a communication system such as a wireless communication network.

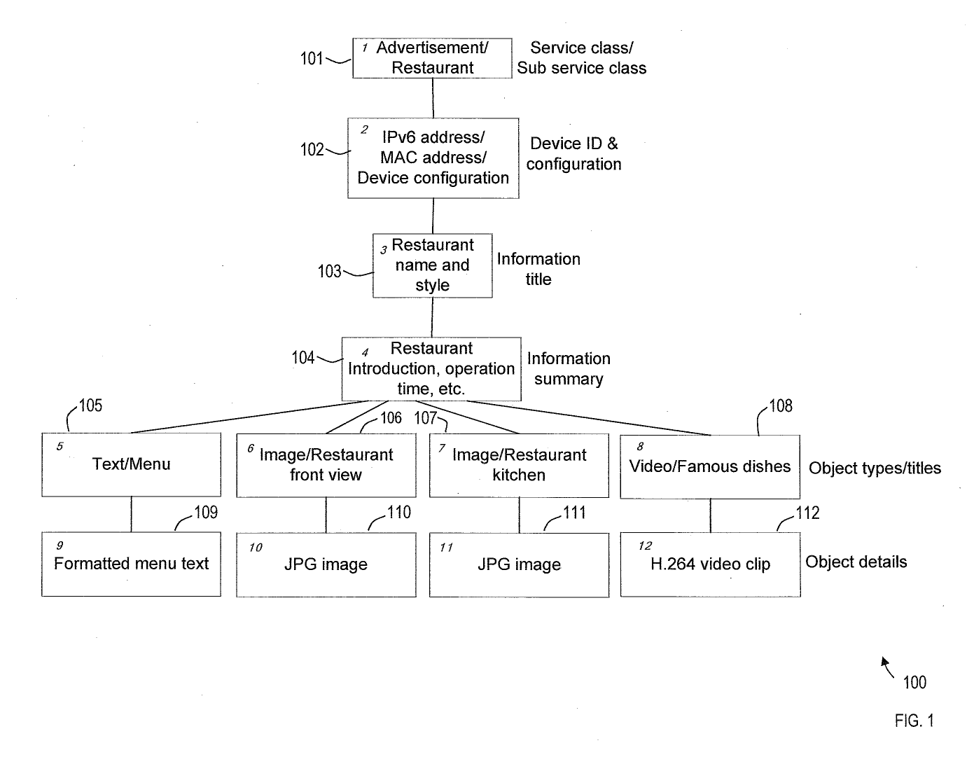

According to an embodiment of the invention, in a scalable packet aggregation scheme, information to be placed in a packet is partitioned based on information type as shown by example in FIG. 1, and then organized (packetized) in an aggregated packet in a pyramid format for simplified adaptation. The type of information can be selected, and one example is illustrated in FIG. 1. In one example, information is placed in an aggregated packet in the order of its importance level.

According to an embodiment of the invention, in a scalable packet structure, information in a packet is organized/coded in a two-dimensional pyramid format for simplified adaptation and aggregation for forwarding information from one or more communication devices. A first dimension includes information importance level and a second dimension includes device priorities based on a “distance” calculation.

According to an embodiment of the invention, the data organization includes three options: (a) ordering the information based on information importance levels first, wherein non-important information at the first dimension for each communication device can be dropped by a forwarding communication device first, (b) ordering the information based on device importance levels first, wherein all information from certain low-priority communication devices (e.g., far away devices, devices that pay less for service subscription) can be dropped by a forwarding communication device first, and (c) ordering information in a fine-granular manner at two dimensions together, wherein information with the lowest priority is dropped by a forwarding communication device first.

A communication device may forward information from other devices (e.g., agent communication devices that perform information forwarding functions), or generally routers and relay nodes may forward information from other communication devices. According to an embodiment of the invention, for communication priority, if an agent communication device receives information from another device which is far away geographically, the agent device may place the information as low priority. In another embodiment, if an agent communication device receives information which it also has interest in, the agent communication device may treat the information as high priority in forwarding.

### Scalable Information Packetization for Single Communication Device (User)

In one implementation, the present invention provides a scalable packet structure for data communication in which information in a packet is organized and coded in a pyramid format for simplified adaptation. A forwarding communication device aggregates and forwards information from one communication device to another communication device. The forwarding communication device performs aggregation and packetization on the information that it receives from one communication device for forwarding to another communication device.

In one implementation, information in an aggregated packet for a single communication device (or user) is organized from top to down as follows:

```
Service class/Sub service class,
    Device Identification (ID) and configuration,
        Information title,
            Information summary,
                Information object types/titles,
                    Information object details
```

An aggregated packet with said pyramid structure can be truncated easily by the forwarding communication device from the end of the aggregated packet.

In one example, for audio/video data, one packet can carry multiple information objects which are ordered according to object types, the amount of data, position of the object in the display, etc. For example, objects can be ordered as text first, then image, sound, animation and finally video. A large object such as video can be spread into multiple packets.

In one example, a simple advertisement segment from a restaurant may include the following information: Restaurant name/address/introduction, restaurant menu in text, multiple restaurant pictures in images, a restaurant audio track, and a half minute restaurant video clip. That information can be organized in packets using said pyramid structure, such as shown in FIG. 1 illustrating a scalable information packetization process 100, according to an embodiment of the invention.

The bold italic digits in the top left corner of each of the information blocks 101-112 indicate the order in which relevant information for each block is placed in an aggregated packet for forwarding (transmitting) from a communication device to another communication device (e.g., in ascending order from lowest number to the highest number). For example, if the amount of video information in r block 112 is too large to be placed in one packet for transmission from a communication device to another communication device, the video information can be placed in one or multiple separate packets.

For packet transmission from a transmitting communication device to a receiving communication, an aggregated packet with said pyramid structure can be truncated easily by the transmitting communication device from the end of the aggregated packet. For example, information in blocks 111 and 112 can be dropped but the user at the receiver side still can generally understand the advertisement information.

### Scalable Information Packetization and Aggregation for Multiple Devices/Users

According to an embodiment of the invention, in order to forward information from multiple communication devices, in a scalable packet structure information in a packet is organized/coded in two-dimensional pyramid format for simplified adaptation and aggregation. In a first dimension, information for each communication device is organized from top to down as described further above.

In a second dimension, because one communication device may aggregate and forward information from different communication devices, the forwarding communication device can prioritize information from different communication devices based on “distance” metrics. In one embodiment, said distance can be calculated based on different aspects such as signal strength or the information relevance with the function of the forwarding device, and so on.

For example, a forwarding communication device may treat the information from another communication device that is near by as high priority for forwarding. When a forwarding communication device has too much information to be forwarded, the forwarding communication device can truncate and drop certain information based on the priorities in said two dimensions.

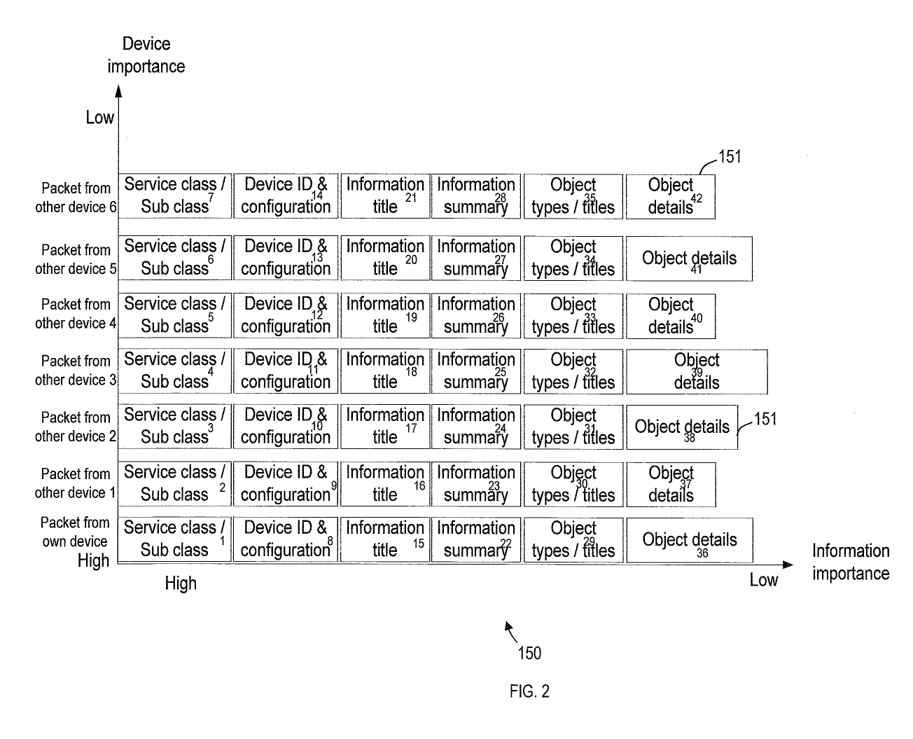

In one embodiment, there are three options for organizing information in an aggregated packet based on said two dimensional priorities, as described below and illustrated in FIGS. 2-4 by example. FIG. 2 shows an example packet organization 150 for scalable information packetization and aggregation based on a first information organization option, according to an embodiment of the invention.

Specifically, the information in an aggregated packet is organized by ordering the information in the packet based on information importance levels first, and non-important (or low importance) information in the first dimension for each communication device is dropped first by a forwarding device as illustrated by example in FIG. 2. The size of an aggregate packet need not (but can) be different from a normal packet, and information is stored in an aggregate packet in a structured manner according to embodiments of the invention (a normal packet contains information in an unstructured manner).

As illustrated in this example, information blocks 151 are organized in two dimensions based on device importance and information importance, wherein the numerals within each information block 151 indicate the priority order in which that information block is placed in an aggregated packet (e.g., block 151 with priority order 1 has highest importance, and block 151 with priority order 42 has the lowest important). A device may forward information sent by other devices (e.g., device 1, device 2, . . . , device 6 in FIG. 2).

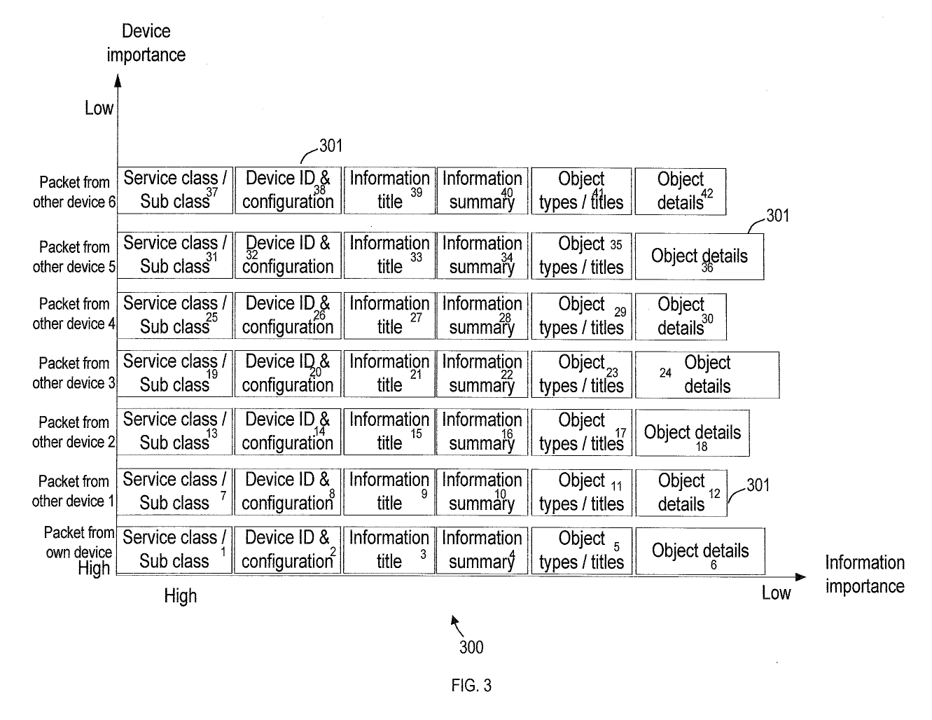

FIG. 3 shows an example packet organization 300 for scalable information packetization and aggregation based on a second information organization option, according to an embodiment of the invention. Specifically, the information in an aggregated packet is organized by ordering the information in the packet based on device importance levels first, and then all information from certain low-priority devices can be dropped first, as shown in FIG. 3 by example.

As illustrated in this example, information blocks 301 are organized in two dimensions based on device importance and information importance, wherein the numerals within each information block 301 indicate the priority order in which that information block is placed in an aggregated packet (e.g., block 301 with priority order 1 has highest importance, and block 301 with priority order 42 has the lowest important).

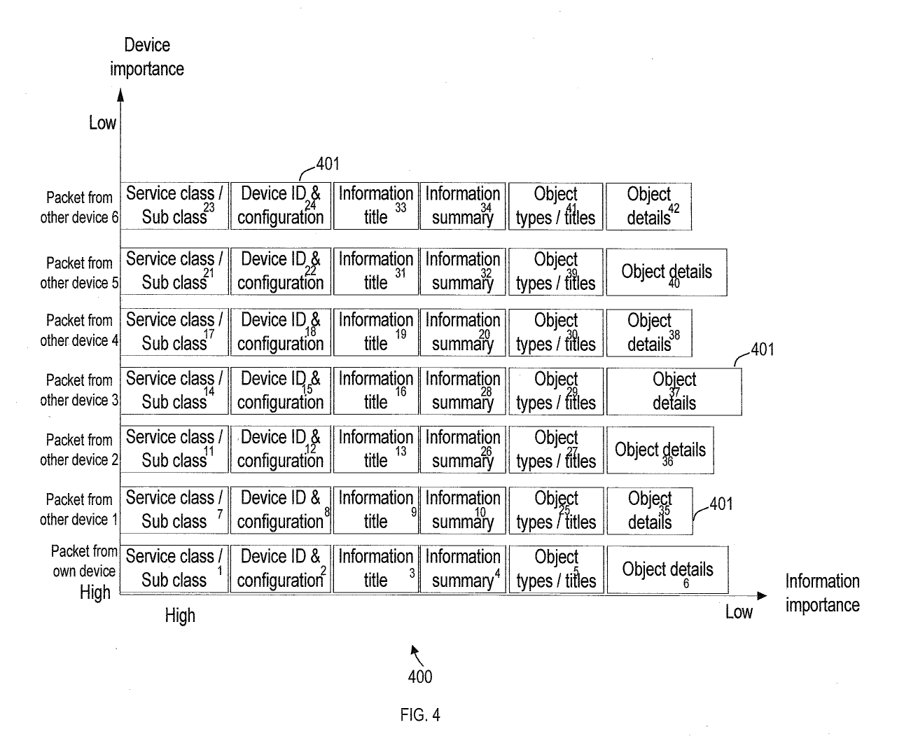

FIG. 4 shows an example packet organization 400 for scalable information packetization and aggregation based on a third information organization option, according to an embodiment of the invention. Specifically, the information in an aggregated packet is organized in a fine-granular manner in two dimensions together, and dropping information first from the lowest priority as indicated as largest order number as shown by example in FIG. 4.

As illustrated in this example, information blocks 401 are organized in two dimensions based on device importance and information importance, wherein the numerals within each information block 401 indicate the priority order in which that information block is placed in an aggregated packet (e.g., block 401 with priority order 1 has highest importance, and block 401 with priority order 42 has the lowest important).

### Scalable Error Detection and Correction Schemes

According to an embodiment of the invention, encoding information including multiple CRCs or other FEC bits can be added to an aggregated packet at different information levels based on information communication reliability requirements. In one example CRC or FEC bits can be added to information in FIG. 2 after block numbers 7, 14, 21, 28, 35 and 42, respectively. In another example, CRC or FEC bits can be added to information in FIG. 4 after block number 6, 24, 34 and 42, respectively.

According to an embodiment of the invention, expressing the scalable information structure in a packet as disclosed herein, allows scalability and improves communication channel access efficiency by reducing the channel access attempts by the communication devices.

In one embodiment, each communication device comprises a communication station for communication with other communication stations over a communication link (communication medium). In one implementation, a communication device includes a processor, memory, logic, transceiver and communication layers such as a network layer, a MAC layer, a PHY layer. The communication can include broadcast communication and directional communication. Examples of applicable wireless communication standards include WiFi, WiGig, LTE, etc.

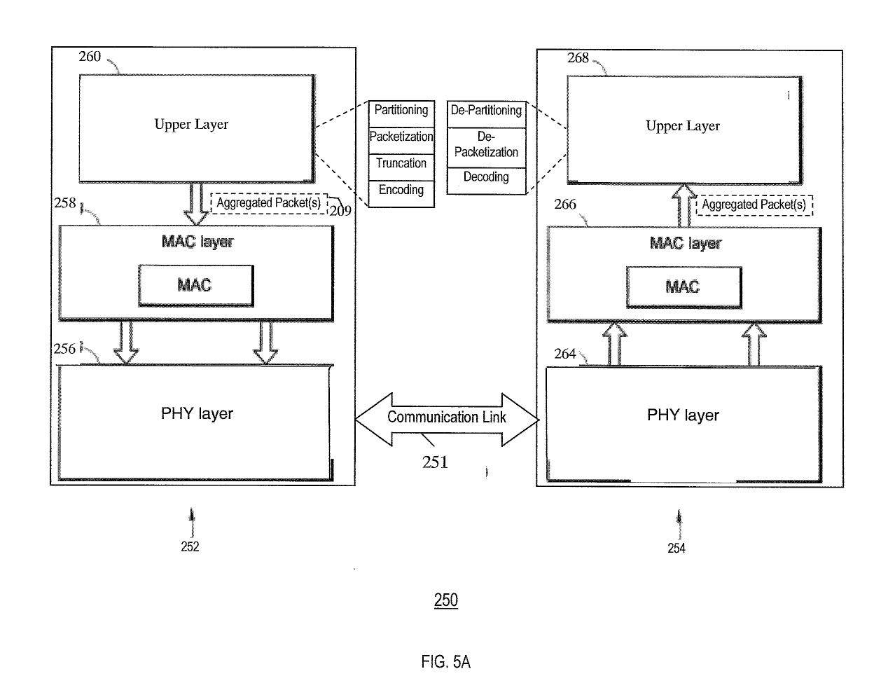

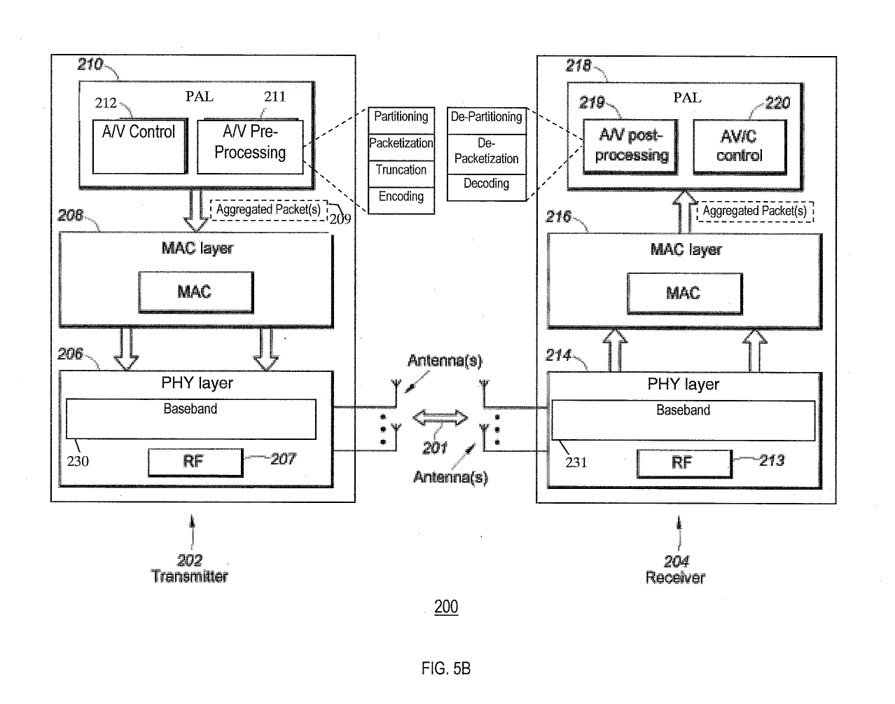

FIG. 5A shows a block diagram of an example communication network system 250, implementing scalable information packetization and aggregation, according to an embodiment of the invention. The system 250 can be a wired network or a wireless network, and embodiments of the invention are useful with wireless networks, wired networks, and combinations thereof. Therefore, embodiments of the invention are not limited to the example wireless and/or wired communication networks described herein by example.

The system 250 includes a communication station (communication device) 252 and a communication station (communication device) 254. The communication stations 252 and 254 communicate via a communication link 251. The communication stations can be wired or wireless, and the communication link therebetween can be wired or wireless.

The station 252 includes a PHY layer 256, a MAC layer 258, and an upper layer 260. The PHY layer 256 comprises a communication module for transmitting/receiving signals via a communication link.

In one example, the upper layer 260 implements scalable information packetization and aggregation according to embodiments of the invention described herein, for packetizing information into one or more aggregated packets 209 which are then converted to MAC packets by the MAC layer 258.

In one embodiment of the upper layer 260, information to be placed in a packet is partitioned (by a partitioning sub-module) based on type and then organized (by a packetization sub-module) in a packet in a pyramid format for simplified adaptation. An aggregated packet 209 with said pyramid structure can be truncated (by a truncation sub-module) from the end of the aggregated packet by the upper layer 260 of the station 252 as needed to meet transmission criteria, for transmission to the station 254 via the communication link 251. Encoding information can also be added to the packet (by an encoding sub-module).

According to an embodiment of the invention, upon communication link adaptation and reduction in available communication channel bandwidth, the upper layer 260 adaptively eliminates information in an aggregated packet from transmission in order to meet available communication channel bandwidth requirements.

The communication station 254 includes a PHY layer 264, a MAC layer 266, and an upper layer 268. The PHY layer 264 comprises a communication module which transmits/receives signals via the communication link. The upper layer 268 implements scalable information packetization and aggregation according to embodiments of the invention described herein, for de-partitioning, de-packetizing and decoding the information in the MAC packets into video streams, received by the MAC layer 266. The de-partitioning, de-packetizing and decoding are reverse of the ones by upper layer 260 of the station 252.

In another embodiment, scalable information packetization and aggregation may be implemented across the upper and MAC layers, or only in the MAC layer.

FIG. 5B shows a block diagram of an example wireless communication network system 200, implementing scalable information packetization and aggregation, for wireless communication of audio/video (AV) information, according to an embodiment of the invention. The system 200 includes a wireless station 202 and a wireless station 204, for wireless data communication, such as wireless transmission of audio/video information over a radio frequency channel 201. The system 200 may include a wireless coordinator device that facilitates communications in the network. In one example, the wireless station 202 functions as a transmitter and the wireless station 204 functions as a receiver.

The wireless station 202 includes a PHY layer 206, a MAC layer 208, and a Protocol Adaptation Layer (PAL) 210. The PHY layer 206 includes a radio frequency (RF) communication module 207 for transmitting/receiving signals under control of a baseband process module 230. The baseband process module 230 allows communicating control information and other information.

In one example, the PAL 210 includes an audio/visual (A/V) pre-processing module 211 implementing scalable information packetization and aggregation according to embodiments of the invention described herein, for packetizing information into one or more aggregated packets 209 which are then converted to MAC packets by the MAC layer 208. The PAL 210 further includes an AV/C control module 212 which sends transmission requests and control commands to reserve radio frequency channel time blocks for transmission of packets.

In one embodiment of the module 211, information to be placed in a packet is partitioned (by a partitioning sub-module) based on type and then organized (by a packetization sub-module) in a packet in a pyramid format for simplified adaptation. An aggregated packet 209 with said pyramid structure can be truncated (by a truncation sub-module) from the end of the aggregated packet by the pre-processing module 211 of the wireless station 202 as needed to meet transmission criteria, for transmission to the wireless station 204. Encoding information can also be added to the packet (by an encoding sub-module).

According to an embodiment of the invention, upon communication link adaptation and reduction in available communication channel bandwidth, the module 211 adaptively eliminates information in an aggregated packet from transmission in order to meet available communication channel bandwidth requirements.

The wireless station 204 includes a PHY layer 214, a MAC layer 216, and a PAL 218. The PHY layer 214 includes a RF communication module 213 which transmits/receives signals under control of a baseband process module 231. The PAL 218 includes an A/V post-processing module 219 implementing scalable information packetization and aggregation according to embodiments of the invention described herein, for de-partitioning, de-packetizing and decoding the information in the MAC packets into video streams, received by the MAC layer 216. The de-partitioning, de-packetizing and decoding are reverse of the ones by A/V pre-processing module 211 in the PAL 210 of wireless transmitter station 202. The PAL 218 further includes an AV/C control module 220 which handles stream control and channel access.

In another embodiment, scalable information packetization and aggregation may be implemented across the PAL and MAC layers, or only in the MAC layer.

In one embodiment, communication may be performed over multiple channels. The MAC/PHY layers of the wireless stations 202 and 204 may perform such communications. An example implementation of the invention in the system 200 for mmWave wireless communication such as for a 60 GHz frequency band wireless network is useful with WiGig applications (e.g., client types, including A/V equipment, network devices, PCs and handhelds). An example WiGig network utilizes a 60 GHz-band mmWave technology to support a physical (PHY) layer data transmission rate of multi-Gbps (gigabits per second).

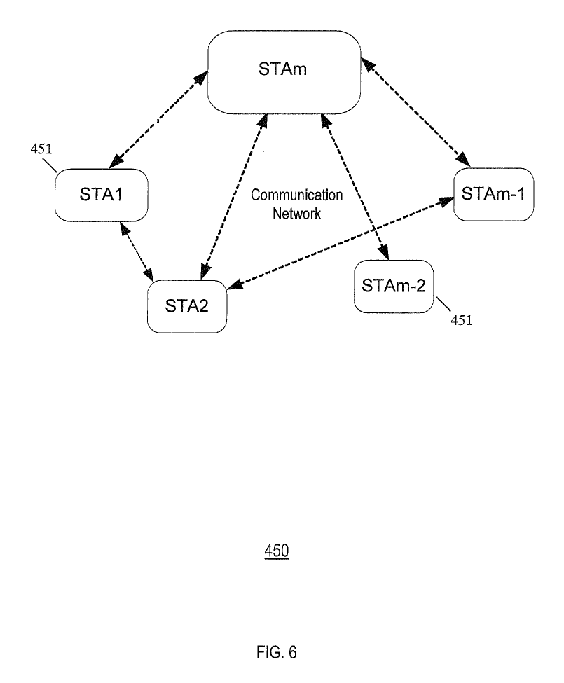

FIG. 6 shows an example network 450 of m communication devices 451 (e.g., communication stations 202, 204 in FIG. 5B, or communication stations 252, 254 in FIG. 5A), implementing scalable information packetization and aggregation, according to an embodiment of the invention. The devices 451 communicate over a communication medium. The communication devices 451 may be wired or wireless devices and the communication network may be wired or wireless.

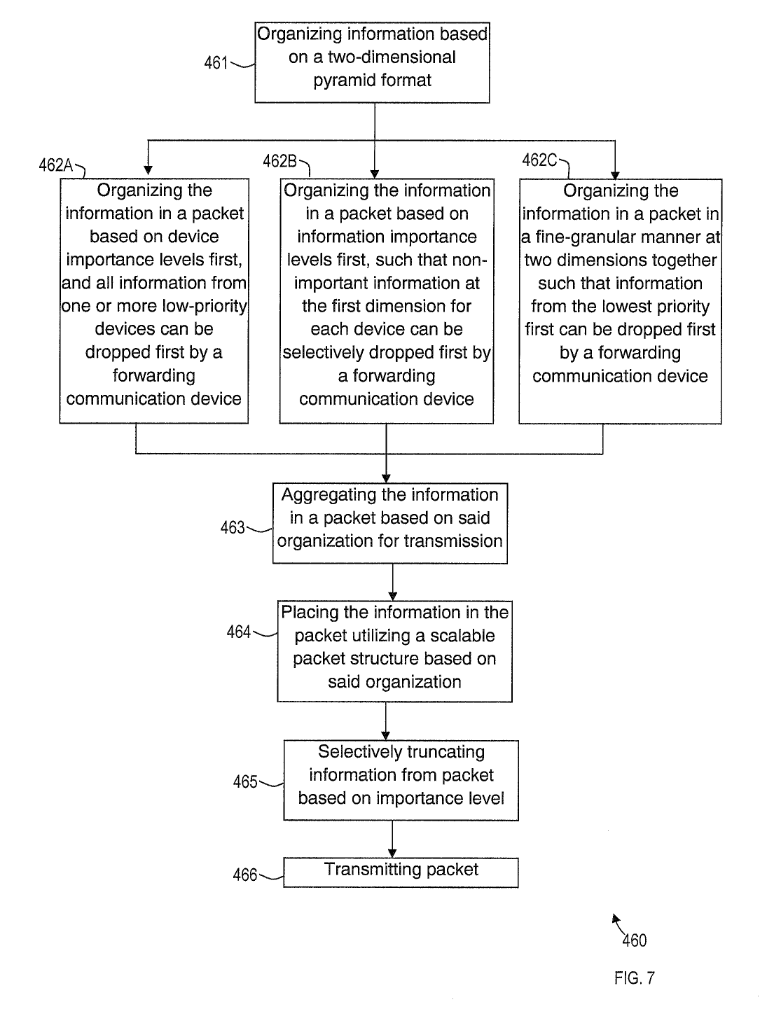

FIG. 7 shows a flowchart of a process 460 for scalable information packetization and aggregation for information transmission in a communication, according to an embodiment of the invention. Process block 461 comprises Organizing information based on criteria such as importance level or two-dimensional pyramid format. One of the process blocks 462A, 462B or 462C is utilized according to embodiments of the invention, wherein process block 462A comprises organizing the information in a packet based on device importance levels first, and all information from one or more low-priority devices can be dropped first by a forwarding communication device.

Process block 462B comprises Organizing the information in a packet based on information importance levels first, such that non-important information at the first dimension for each device can be selectively dropped first by a forwarding communication device. Process block 462C comprises organizing the information in a packet in a fine-granular manner at two dimensions together such that information from the lowest priority first can be dropped first by a forwarding communication device.

Process block 463 comprises aggregating the information in a packet based on said organization for transmission. Process block 464 comprises placing the information in the packet utilizing a scalable packet structure based on said organization. Process block 465 comprises at a forwarding device selectively truncating information from packet based on importance level. Process block 466 comprises transmitting the packet over communication channel.

According to embodiments of the invention, expressing the scalable information structure in a packet as disclosed herein, allows scalability and improves communication channel access efficiency by reducing the channel access attempts by the communication devices. In one embodiment, information about importance level (including the two-dimensional format) is placed in the packet such that a forwarding device can utilize that information in determining which information to truncate. In one embodiment of the invention, the importance level information can be at the beginning of the aggregated packet (e.g., in the packet header), or embedded into each information block and at the beginning of each information block, in the aggregated packet. In addition to importance level information, the length of an information block and optionally other information such as keywords may also be included in an aggregated packet. In one implementation, when such information is at the beginning of the packet (e.g., packet header), the starting position of each information block is also included. Further, a receiving device may utilize such information for processing the information in a received aggregated packet.

As is known to those skilled in the art, the aforementioned example architectures described above, according to said architectures, can be implemented in many ways, such as program instructions for execution by a processor, as software modules, microcode, as computer program product on computer readable media, as analog/logic circuits, as application specific integrated circuits, as firmware, as consumer electronic devices, AV devices, wireless/wired transmitters, wireless/wired receivers, networks, multi-media devices, etc. Further, embodiments of said Architecture can take the form of an entirely hardware embodiment, an entirely software embodiment or an embodiment containing both hardware and software elements.

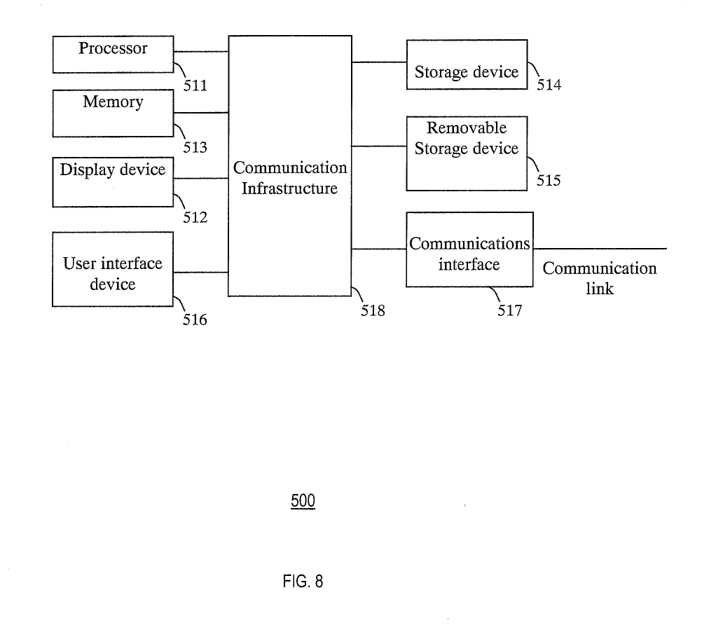

FIG. 8 is a high level block diagram showing an information processing system comprising a computer system 500 useful for implementing an embodiment of the present invention. The computer system 500 includes one or more processors 511, and can further include an electronic display device 512 (for displaying graphics, text, and other data), a main memory 513 (e.g., random access memory (RAM)), storage device 514 (e.g., hard disk drive), removable storage device 515 (e.g., removable storage drive, removable memory module, a magnetic tape drive, optical disk drive, computer readable medium having stored therein computer software and/or data), user interface device 516 (e.g., keyboard, touch screen, keypad, pointing device), and a communication interface 517 (e.g., modem, a network interface (such as an Ethernet card), a communications port, or a PCMCIA slot and card). The communication interface 517 allows software and data to be transferred between the computer system and external devices. The system 500 further includes a communications infrastructure 518 (e.g., a communications bus, cross-over bar, or network) to which the aforementioned devices/modules 511 through 517 are connected.

Information transferred via communications interface 517 may be in the form of signals such as electronic, electromagnetic, optical, or other signals capable of being received by communications interface 517, via a communication link that carries signals and may be implemented using wire or cable, fiber optics, a phone line, a cellular phone link, an radio frequency (RF) link, and/or other communication channels. Computer program instructions representing the block diagram and/or flowcharts herein may be loaded onto a computer, programmable data processing apparatus, or processing devices to cause a series of operations performed thereon to produce a computer implemented process.

Embodiments of the present invention have been described with reference to flowchart illustrations and/or block diagrams of methods, apparatus (systems) and computer program products according to embodiments of the invention. Each block of such illustrations/diagrams, or combinations thereof, can be implemented by computer program instructions. The computer program instructions when provided to a processor produce a machine, such that the instructions, which execute via the processor create means for implementing the functions/operations specified in the flowchart and/or block diagram. Each block in the flowchart/block diagrams may represent a hardware and/or software module or logic, implementing embodiments of the present invention. In alternative implementations, the functions noted in the blocks may occur out of the order noted in the figures, concurrently, etc.

The terms “computer program medium,” “computer usable medium,” “computer readable medium”, and “computer program product,” are used to generally refer to media such as main memory, secondary memory, removable storage drive, a hard disk installed in hard disk drive. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Computer program instructions may be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Computer programs (i.e., computer control logic) are stored in main memory and/or secondary memory. Computer programs may also be received via a communications interface. Such computer programs, when executed, enable the computer system to perform the features of the present invention as discussed herein. In particular, the computer programs, when executed, enable the processor and/or multi-core processor to perform the features of the computer system. Such computer programs represent controllers of the computer system.

Though the present invention has been described with reference to certain versions thereof; however, other versions are possible. Therefore, the spirit and scope of the appended claims should not be limited to the description of the preferred versions contained herein.

What is claimed is:

1. A method for information communication in a communication network, comprising:
organizing information based on importance levels of the information; and
aggregating the information in a packet based on said organization for transmission over a communication medium;
wherein aggregating the information comprises placing the information in the aggregated packet utilizing a scalable packet structure based on said organization.

2. The method of claim 1, further comprising:
selectively truncating information from the aggregated packet based on said importance levels to meet communication criteria.

3. The method of claim 1, further comprising:
aggregating the information in a packet wherein information in the packet is organized based on a two-dimensional pyramid format.

4. The method of claim 3, wherein:
a first dimension comprises information importance level; and
a second dimension comprises communication device priorities.

5. The method of claim 4, wherein:
the second dimension comprises communication device priorities based on a distance calculation.

6. The method of claim 4, further comprising:
organizing the information in a packet based on information importance levels first, and non-important information at the first dimension for each device is selectively dropped by a forwarding communication device first.

7. The method of claim 4, further comprising:
organizing the information in a packet based on device importance levels first, and all information from one or more low-priority devices is dropped first.

8. The method of claim 4, further comprising:
organizing the information in a packet in a fine-granular manner at two dimensions together and dropping information from the lowest priority first.

9. The method of claim 4, further comprising:
appending error detection and/or error correction information to the packet at different information importance levels based on reliability requirements.

10. The method of claim 1, wherein the communication network comprises a wireless communication network.

11. The method of claim 1, wherein the communication network comprises a wired communication network.

12. The method of claim 1, further comprising:
including importance level information in a packet.

13. The method of claim 12, further comprising:
including length of an information block in a packet and starting position of the information block in the packet.

14. The method claim 13, further comprising:
including keyword information in a packet.

15. A communication station for communication with at least another communication station, comprising:
a processing module that organizes information based on importance levels of the information, and aggregates the information in a packet based on said organization for transmission over a communication medium;
wherein the processing module aggregates the information by placing the information in the aggregated packet utilizing a scalable packet structure based on said organization; and
a communication module for communicating the aggregated packet over a communication medium.

16. The communication station of claim 15, wherein:
the processing module selectively truncates information from the aggregated packet based on said importance levels to meet communication criteria.

17. The communication station of claim 15, wherein:
the processing module aggregates the information in an aggregated packet wherein information in the aggregated packet is organized based on a two-dimensional pyramid format.

18. The communication station of claim 17, wherein:
a first dimension comprises information importance level; and
a second dimension comprises communication station priorities.

19. The communication station of claim 18, wherein:
the second dimension comprises communication station priorities based on a distance calculation.

20. The communication station of claim 18, wherein:
the processing module organizes the information in an aggregated packet based on information importance levels first, and non-important information at the first dimension for each communication station is selectively dropped by a forwarding communication station first.

21. The communication station of claim 18, wherein:
the processing module organizes the information in a packet based on communication station importance levels first, and all information from one or more low-priority communication stations is dropped first.

22. The communication station of claim 18, wherein:
the processing module organizes the information in an aggregated packet in a fine-granular manner at two dimensions together and dropping information from the lowest priority first.

23. The communication station of claim 18, wherein:
the processing module appends error detection and/or error correction information to the aggregated packet at different information importance levels based on reliability requirements.

24. The communication station of claim 15, wherein an aggregated packet includes importance level information.

25. The communication station of claim 24, wherein an aggregated packet includes length of an information block and starting position of the information block in the packet.

26. A communication system, comprising:
a first communication station and a second communication station for communication information over a communication medium;
wherein the first communication station comprises:
a processing module that organizes information based on importance levels of the information, and aggregates the information in a packet based on said organization for transmission over a communication medium, wherein the processing module aggregates the information by placing the information in the aggregated packet utilizing a scalable packet structure based on said organization; and
a communication module for communicating the aggregated packet over a communication medium.

27. The communication system of claim 26, wherein:
the processing module selectively truncates information from the aggregated packet based on said importance levels to meet communication criteria.

28. The communication system of claim 26, wherein:
the processing module aggregates the information in an aggregated packet wherein information in the aggregated packet is organized based on a two-dimensional pyramid format.

29. The communication system of claim 28, wherein:
a first dimension comprises information importance level; and
a second dimension comprises communication station priorities.

30. The communication system of claim 29, wherein:
the second dimension comprises communication station priorities based on a distance calculation.

31. The communication system of claim 29, wherein:
the processing module organizes the information in an aggregated packet based on information importance levels first, and non-important information at the first dimension for each communication station is selectively dropped by a forwarding communication station first.

32. The communication system of claim 29, wherein:
the processing module organizes the information in a packet based on communication station importance levels first, and all information from one or more low-priority communication stations is dropped first.

33. The communication system of claim 29, wherein:
the processing module organizes the information in an aggregated packet in a fine-granular manner at two dimensions together and dropping information from the lowest priority first.

34. The communication system of claim 29, wherein:
the processing module appends error detection and/or error correction information to the aggregated packet at different information importance levels based on reliability requirements.

35. The communication system of claim 26, wherein an aggregated packet includes importance level information.

36. The communication station of claim 35, wherein an aggregated packet includes length of an information block and starting position of the information block in the packet.

37. The communication system of claim 26, wherein the second communication device includes a communication module configured for receiving an aggregated packet, and a processing module configured for retrieving the information from an aggregated packet.

38. The communication station of claim 26, wherein:
the processing module selectively truncates information from the aggregated packet by truncating low priority information first.
